(19) United States
(12) Patent Application Publication
(10) Pub. No.: US 2007/0175938 A1
(43) Pub. Date: Aug. 2, 2007

(54) Collapsible cargo carrier

(76) Inventor: Chris M. Swenson, City of Amarillo, TX (US)

Correspondence Address: HITT GAINES P.C., P.O. BOX 832570, RICHARDSON, TX, 75083, US

(21) Appl. No.: 11/341,123

(22) Filed: Jan. 27, 2006

(51) Int. Cl. B60R 11/00; B60R 9/00

(52) U.S. Cl. 224/498; 224/519

(57) ABSTRACT

A collapsible cargo carrier for use with a vehicle tow bar receiver, the cargo carrier comprising: a draw bar having a top side and first and second ends, and a pivot frame having a pin coupled therethrough. In one embodiment, the draw bar is coupleable to a vehicle tow bar receiver at the first end, and the draw bar has a first aperture and a keyway through the top side proximate the second end. The pin has a key thereon, wherein the pin and the key are configured to cooperate with the first aperture and the keyway to removeably couple the pivot frame to the draw bar. A method of manufacturing a collapsible cargo carrier is also provided.

### TECHNICAL FIELD OF THE INVENTION

The present invention is directed, in general, to cargo carriers and, more specifically, to a collapsible cargo carrier for use with a trailer hitch receiver.

### BACKGROUND OF THE INVENTION

The need to carry cargo exceeding the within-vehicle capacity has likely been with mankind since the introduction of vehicles. Numerous approaches have been formulated to address this need. With the introduction of the motor vehicle and its considerable horsepower, the opportunity was met to some degree by coupling a trailer to the towing vehicle.

However, sometimes it is necessary to carry some cargo that does not warrant the use of a separate trailer, although the towing vehicle is equipped with a tow bar receiver. Some approaches to this problem have been specific to the type of cargo, e.g., golf bags, and are therefore not generally adaptable to miscellaneous cargo. Other approaches provide a container within which the miscellaneous cargo can be stowed. These typically also address access to the vehicle trunk through some type of extension mechanism, and are therefore quite complicated. Another approach provides a fixed platform that couples to the tow bar receiver, thereby being a potential storage problem because of its size. Additionally, there is considerable effort today to downsize vehicles to the minimum size suitable for day to day use and conserving gasoline, thus making the transport of cargo a more difficult problem.

Accordingly, what is needed in the art is a collapsible cargo carrier that removeably couples to a tow bar receiver that does not suffer from the deficiencies of the prior art.

### SUMMARY OF THE INVENTION

To address the above-discussed deficiencies of the prior art, the present invention provides a collapsible cargo carrier for use with a vehicle tow bar receiver, the cargo carrier comprising: a draw bar having a top side and first and second ends, and a pivot frame having a pin coupled therethrough. In one embodiment, the draw bar is coupleable to a vehicle tow bar receiver at the first end, and the draw bar has a first aperture and a keyway through the top side proximate the second end. The pin has a key thereon; the pin and the key are configured to cooperate with the first aperture and the keyway to removeably couple the pivot frame to the draw bar. A method of manufacturing a collapsible cargo carrier is also provided.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawing, in which:

FIG. 1 illustrates an isometric view of one embodiment of a collapsible cargo carrier constructed according to the principles of the present invention;

FIG. 2 illustrates an isometric view of the draw bar of FIG. 1;

FIG. 3A illustrates an isometric view of the main frame;

FIG. 3B illustrates an isometric view of the pivot frame;

FIG. 3C illustrates an isometric view of the primary support members of FIG. 1;

FIG. 3D illustrates an isometric view of the second extenders of FIG. 1;

FIG. 3E illustrates an isometric view of the first extenders of FIG. 1;

FIG. 3F illustrates an isometric view of the end frames of FIG. 1;

FIG. 3G illustrates a close up, plan view of one end frame in relation to a first extender;

FIG. 4 illustrates an isometric view of the collapsible cargo carrier as it is bundled for shipping and for storage; and

FIG. 5 illustrates a rear isometric view of the collapsible cargo carrier of FIG. 1 in its fully collapsed form.

### DETAILED DESCRIPTION

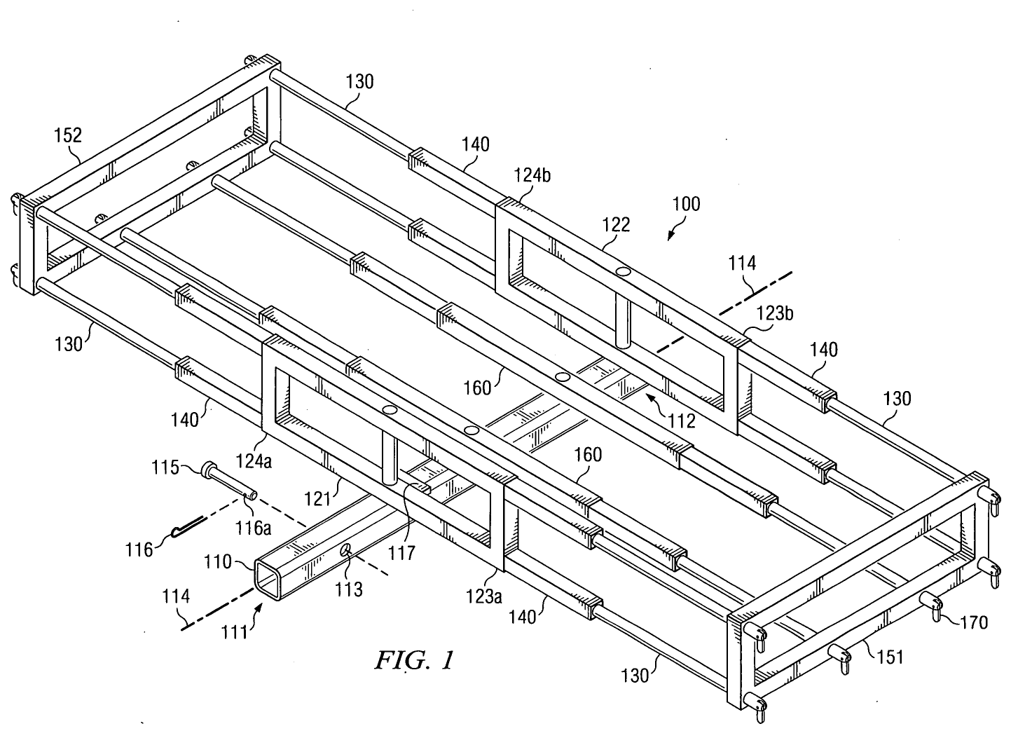

Referring initially to FIG. 1, illustrated is an isometric view of one embodiment of a collapsible cargo carrier 100 constructed according to the principles of the present invention. The cargo carrier 100 comprises a draw bar 110, a main frame 121, a pivot frame 122, a plurality of first extenders 130, a plurality of second extenders 140, and first and second end frames 151, 152. In one embodiment, the draw bar 110 has first and second ends 111, 112, respectively; a draw pin aperture 113; a longitudinal axis 114 and a stop block 117. In a preferred embodiment, the first end 111 is coupleable to a receiver of a towing vehicle (not shown) and secured in place with a draw pin 115 and a security pin 116 that fits through a security pin hole 116a in the draw pin 115. One who is of skill in the art is knowledgeable of how the collapsible cargo carrier 100 is coupled to the receiver of a towing vehicle. In a preferred embodiment, the main frame 121 and the pivot frame 122 are removeably coupleable to the draw bar 110 and perpendicular to the longitudinal axis 114. The main frame 121 and the pivot frame 122 have first and second opposing ends 123a, 123b, 124a, 124b, respectively. The collapsible cargo carrier 100 further comprises one or more primary support members 160 and a plurality of flop locks 170. In the illustrated embodiment, two primary support members 160 are shown. However, one who is of skill in the art will recognize that the number of primary support members 160 may be varied to assure support of a load (not shown) to be carried in the collapsible cargo carrier 100.

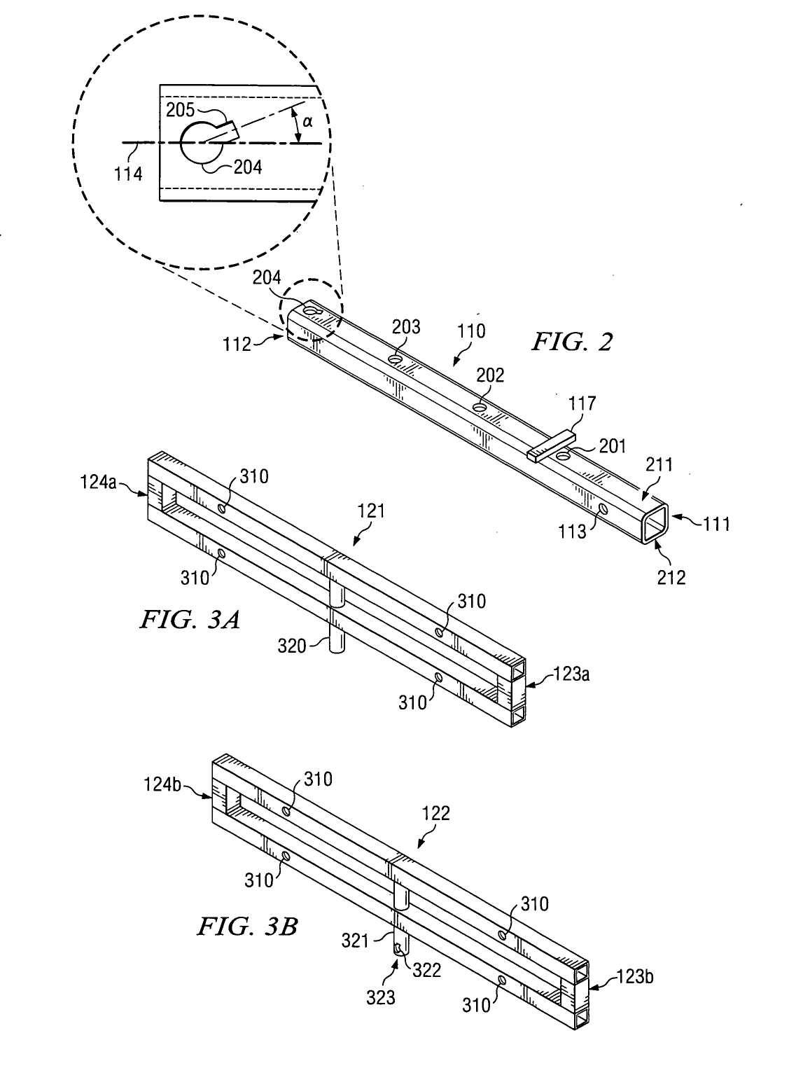

Referring now to FIG. 2, illustrated is an isometric view of the draw bar 110 of FIG. 1. In a preferred embodiment, the draw bar 110 comprises 2-inch square aluminum tubing having first and second ends 111, 112, a top wall 211, a bottom wall 212, and the stop block 117. The draw pin aperture 113 is proximate the first end 111. The draw bar 110 further comprises first, second, third and fourth apertures 201, 202, 203, 204 respectively, through both the top and bottom walls 211, 212, respectively. The fourth aperture 204 is proximate the second end 112 and has a keyway 205 also cut through the top and bottom walls 211, 212. The stop block 117 is welded to the top wall 211 proximate the first end 111 and perpendicular to the longitudinal axis 114. The inset shows the detail of the fourth aperture 204 and the keyway 205. In one embodiment, the keyway 205 is offset by an angle α from the longitudinal axis 114. In one embodiment, the angle a is about 20°. In a preferred embodiment, the angle a is 22.5°.

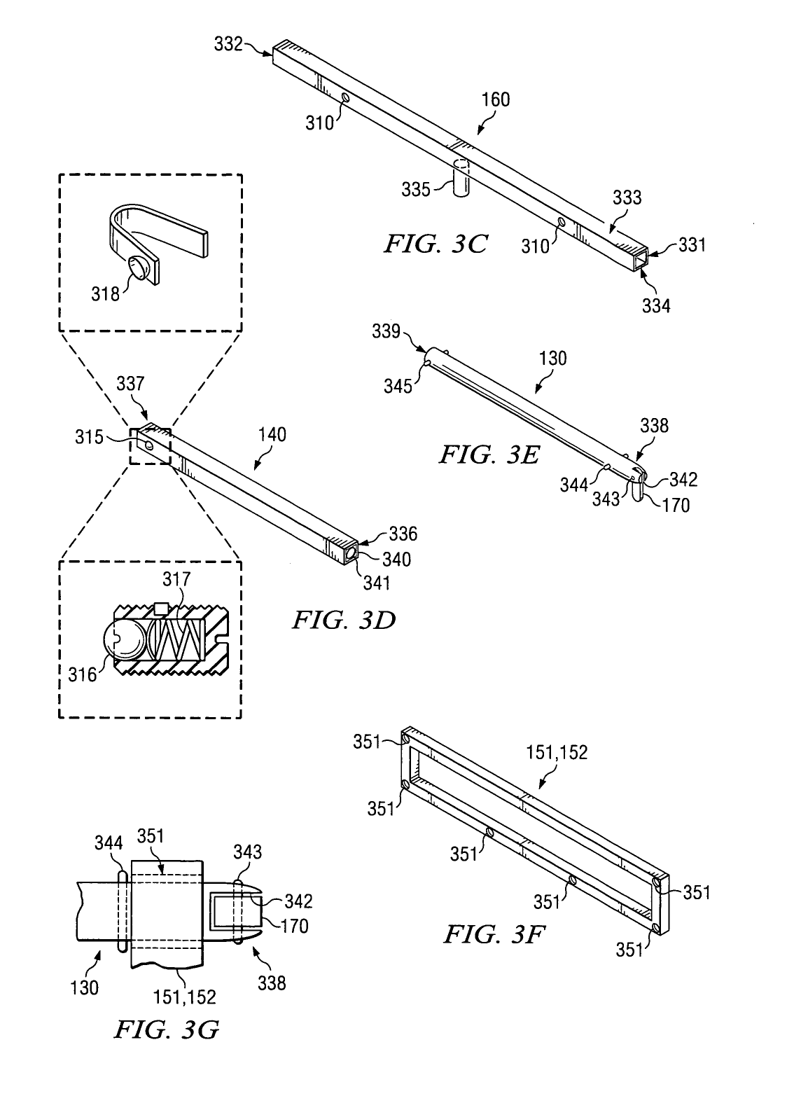

Referring now to FIGS. 3A and 3B, illustrated are isometric views of the main frame 121 and the pivot frame 122, respectively, of FIG. 1. In one embodiment, the main frame 121 and the pivot frame 122 comprise rectangular aluminum tubing. In a preferred embodiment, the main frame 121 and pivot frame 122 comprise 1-inch square, 3/16 inch wall thickness, aluminum tubing having first and second ends 123a, 123b, 124a, 124b, respectively and a plurality of ball stop apertures 310. The main frame 121 further comprises a centrally-located, main frame support pin 320, while the pivot frame 122 further comprises a centrally-located, pivot frame support pin 325. In a preferred embodiment, the main frame support pin 320 is a smooth, chamfered, aluminum pin of ¾-inch diameter and the pivot frame support pin 321 is a smooth, chamfered, aluminum pin of ¾-inch diameter having a key 322 located thereon proximate a lower end 323 of the pivot frame support pin 321.

Referring now to FIG. 3C, illustrated is an isometric view of the primary support members 160 of FIG. 1. In one embodiment, the support members 160 comprise rectangular aluminum tubing. In a preferred embodiment, the primary support members 160 comprise 1-inch square, ⅛-inch wall thickness, aluminum tubing having first and second ends 331, 332, a top wall 333, a bottom wall 334, a support member pin 335 and a plurality of ball stop apertures 310. The support member pin 335 is a smooth, chamfered, aluminum pin of ¾-inch diameter.

Referring now to FIG. 3D, illustrated is an isometric view of the second extenders 140 of FIG. 1. In one embodiment, the second extenders 140 comprise rectangular aluminum tubing. In a preferred embodiment, the second extenders 140 comprise ¾-inch square, ⅛-inch wall thickness, aluminum tubing having first and second ends 336, 337, a ball stop 315, and an end cap 340. The ball stop 315 may be constructed from a ball plunger (see first inset) comprising a ½-inch ball 316 and a spring 317. Alternatively, a single end, straight spring leg snap button 318 (see second inset) may also be used. The end cap 340 has a ½-inch aperture 341 formed therethrough.

Referring now to FIG. 3E, illustrated is an isometric view of the first extenders 130 of FIG. 1. In a preferred embodiment, the first extenders 130 may comprise ½-inch round, solid aluminum having first and second ends 338, 339, and a first cross pin 344 and a second cross pin 345. The second cross pin 345 extends through the second end 339 and is substantially a length of the inside diagonal of the second extender 140. Each first extender 130 has a slot 342 in the first end 338 with the flop lock 170 held in the slot 342 by a pivot pin 343. The flop locks 170 may be of a symmetric, oval shape but weighted in one of the long ends as shown in FIG. 1, or may be racetrack shape with a pivot hole off-center, creating two portions so that one portion is longer and therefore heavier than the other portion. The first cross pin 344 extends through the first extender 130 at a point approximately ¾ inch from the inboard end of the slot 342.

Referring now to FIG. 3F, illustrated is a close up, plan view of one end frame 151 in relation to a first extender 130. In a preferred embodiment, the end frames 151, 152 comprise ¾-inch square, ⅛-inch wall thickness, aluminum tubing having a plurality of apertures 351 therethrough. The plurality of apertures 351 allow the flop locks 170 and the first end 338 of the first extenders 130 to pass through.

Referring now to FIG. 3G, illustrated is a close up plan view of the assembly of one end frame 151, 152 to a first extender 130. The relationship of the flop lock 170, slot 342, pivot pin 343, aperture 351, and first cross pin 344 is readily seen. The first cross pin 344 keeps the first and second end frames 151, 152 trapped proximate the first end 338 of the first extenders 130.

Referring now to FIGS. 3A-3G as required, assembly of the collapsible cargo carrier 100 will be discussed. Only one collapsible member 130, 140 will be discussed for the purposes of simplicity, it being obvious to one who is skilled in the art to repeat the assembly with the analogous parts. The flop lock 170 may be rotated to align with the centerline of the first extender 130 and then inserted into the second end 337 of the second extender 140 until the flop lock 170 passes through the aperture 341 in the second extender end cap 340. The first extender 130 is prevented from being withdrawn from the second extenders 140 by the end cap 344 that conforms to the interior rectangular cross section of the second extenders 140. The second end 337 of the second extender 140 as just assembled is inserted into the first end 123b of the pivot frame 122 until the ball stop 315 encounters the pivot frame first end 123b. The ball stop 315 is then depressed and the remainder of the second extender 140 is inserted into the pivot frame 122.

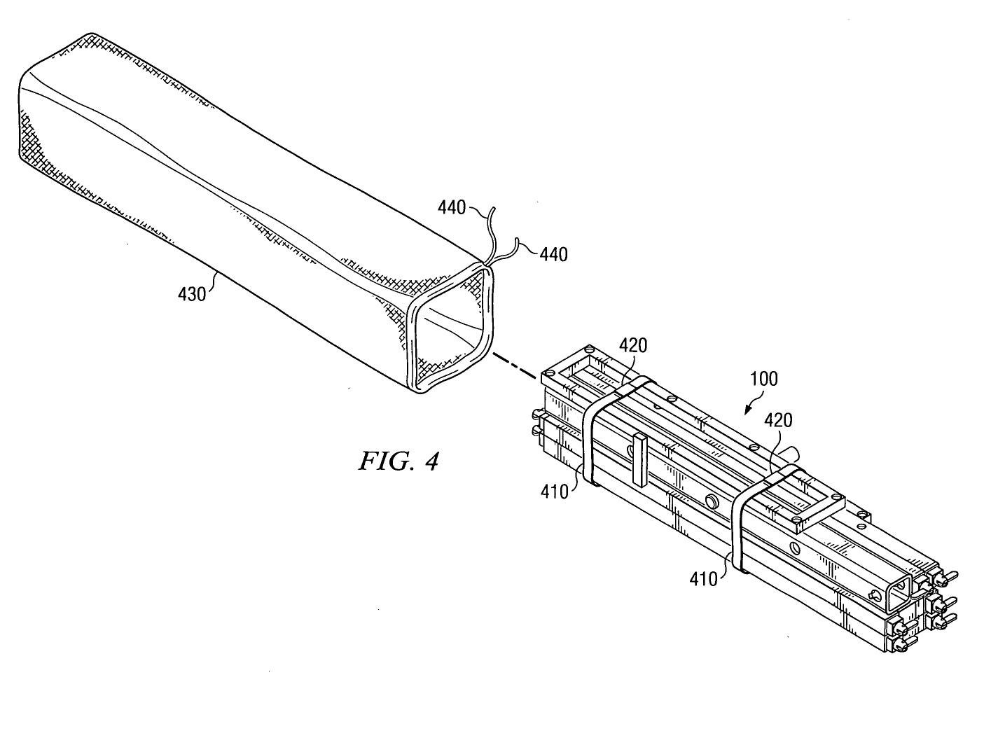

Referring now to FIG. 4, illustrated is an isometric view of the collapsible cargo carrier 100 as it is bundled for shipping and for storage. The collapsible cargo carrier 100 in this configuration may be conveniently held together with straps 410 around the bundle and secured end to end with hook and pile fasteners 420. The bundle may then be stowed into a storage bag 430 of similar size to those currently used for folding chairs. The bag 430 may then be closed with drawstrings 440 or zipper (not shown). This entire light weight, bagged assembly may be conveniently stored behind a seat of vehicles and readily assembled at any location when additional cargo space is needed.

Referring now to FIGS. 1, 2 and 3A-3F, assembly of the collapsible cargo carrier 100 will now be discussed. The first end 111 of the draw bar 110 is inserted into the vehicle receiver (not shown), a draw pin 115 is inserted through the receiver and through the draw pin aperture 113. The security pin 116 is then inserted through the aperture 116a in the draw pin 115. The main frame 121 is then placed on the draw bar 110 with main frame support pin 320 inserted into first aperture 201. The stop block 117 keeps the main frame 121 normal to the draw bar 110. Two primary support members 160 are placed on the draw bar 110 with support member pins 335 inserted into the second and third apertures 202, 203.

Pivot frame 122 is placed on the draw bar 110 at the fourth aperture 204 with the pivot frame 122 at an angle so as to align the key 322 of pivot frame support pin 321 with the keyway 205. With the pivot frame support pin 321 all the way through the fourth aperture 204, the pivot frame 121 is rotated clockwise to a position substantially normal to the draw bar 110 and substantially parallel to the primary support members 160 and the main frame 121. This position for the pivot frame 122 causes the key 322 to be below the bottom wall 212 and out of alignment with the keyway 205, thereby preventing removal of the pivot frame 122.

The first and second extenders 130, 140 are withdrawn from the main frame 121, pivot frame 122 and the primary support members 160 until the second cross pins 345 contact the end caps 340 and the ball stops 315 engage the apertures 351. The flop locks 170 are substantially aligned with the first extenders 130 and inserted through apertures 351 of the end frames 151, 152 and released. The flop locks 170, with the assistance of gravity, lock the end frames 151, 152 onto the first extenders 130. With the end frames 151, 152 in place, the pivot frame 122 is prevented from rotating thereby locking all of the parts together. The collapsible cargo carrier 100 is ready for use. If desired, cargo containers may be placed directly in and secured by tie downs to the expandable cargo carrier 100. A panel (not shown) may be placed within the collapsible cargo carrier 100 and on the primary support members 160. Cargo containers may then be placed thereon and the cargo secured to the expandable cargo carrier 100 with tie downs (not shown). To break down the collapsible cargo carrier 100, the above steps are reversed.

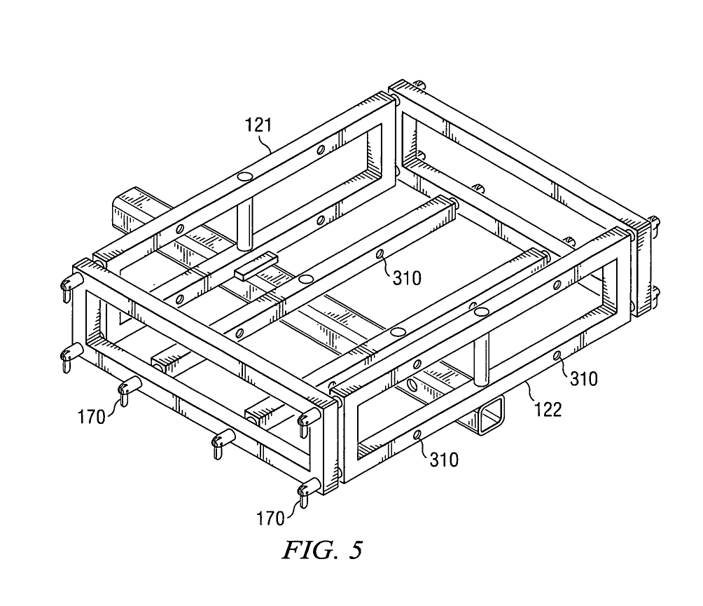

Referring now to FIG. 5, illustrated is a rear isometric view of the collapsible cargo carrier 100 of FIG. 1 in its fully collapsed form. The collapsible cargo carrier 100 may be used in this configuration for reasonably small loads while retaining the opportunity to extend the first and second extenders 130, 140 for additional capacity.

Thus, a collapsible cargo carrier 100 has been described for use with a conventional towing vehicle. The collapsible cargo carrier 100 is conveniently expanded to a size capable of carrying considerable cargo while enabling the breakdown and packaging of the cargo carrier 100 in a reasonably small, lightweight package.

Although the present invention has been described in detail, those skilled in the art should understand that they can make various changes, substitutions and alterations herein without departing from the spirit and scope of the invention in its broadest form.

What is claimed is:

1. For use with a vehicle tow bar receiver, a collapsible cargo carrier, comprising:
a draw bar having a top side and first and second ends, said draw bar coupleable to a vehicle tow bar receiver at said first end, said draw bar having a first aperture and a keyway through said top side proximate said second end; and
a pivot frame having a pin coupled therethrough, said pin having a key thereon, said pin and said key configured to cooperate with said first aperture and said keyway to removeably couple said pivot frame to said draw bar.

2. The cargo carrier as recited in claim 1 wherein said draw bar has a centerline and further comprising:
a stop block coupled to said top side and perpendicular to said centerline; and
a main frame removeably coupleable to said draw bar, said main frame perpendicular to said centerline and proximate said stop block.

3. The cargo carrier as recited in claim 1 wherein said pivot frame has a first end and further comprising a first extender coupleable to said pivot frame first end.

4. The cargo carrier as recited in claim 3 further comprising a second extender coupleable to said pivot frame first end and said first extender, said first extender configured to telescope into said second extender.

5. The cargo carrier as recited in claim 4 wherein said pivot frame and said second extender comprise rectangular tubing, said second extender configured to telescope into said main frame.

6. The cargo carrier as recited in claim 4 wherein said second extender further comprises a ball stop configured to cooperate with a second aperture in a side of said pivot frame.

7. The cargo carrier as recited in claim 3 further comprising:
an end frame removeably coupleable to an outboard end of said first extender;
a slot in said outboard end; and
a flop lock alignable within said slot and configured to enable said flop lock and a portion of said outboard end to pass through a third aperture in said end frame.

8. The cargo carrier as recited in claim 7 wherein said flop lock is rotatably coupled to said outboard end, said flop lock configured to releaseably couple said end frame to said first extender.

9. The cargo carrier as recited in claim 7 further comprising a pivot pin installed through said outboard end at said slot, said flop lock pivoting about said pivot pin.

10. The cargo carrier as recited in claim 7 wherein said flop lock is unbalanced about said pivot pin.

11. The cargo carrier as recited in claim 7 wherein said flop lock has a weighted end.

12. The cargo carrier as recited in claim 7 further comprising an end stop proximate said outboard end and said end frame is positionable on said first extender between said end stop and said flop lock.

13. A method of manufacturing an expandable cargo carrier for use with a vehicle tow bar receiver, comprising:
providing a draw bar having a top side and first and second ends, said draw bar coupleable to a vehicle tow bar receiver at said first end;
forming a first aperture and a keyway through said top side proximate said second end; and
coupling a pin through a pivot frame, said pin having a key thereon, said pin and said key configured to cooperate with said first aperture and said keyway to removeably couple said pivot frame to said draw bar.

14. The method as recited in claim 13 wherein said draw bar has a centerline and further comprising:
coupling a stop block to said top side and perpendicular to said centerline; and
removeably coupling a main frame to said draw bar, said main frame perpendicular to said centerline and proximate said stop block.

15. The method as recited in claim 13 wherein said pivot frame has a first end and further comprising coupling a first extender to said pivot frame first end.

16. The method as recited in claim 15 further comprising coupling a second extender to said pivot frame first end and said first extender, and configuring said first extender to telescope into said second extender.

17. The method as recited in claim 16 wherein said pivot frame and said second extender comprise rectangular tubing and further comprising configuring said second extender to telescope into said main frame.

18. The method as recited in claim 16 further comprising installing a ball stop in said second extender and configuring said ball stop to cooperate with a second aperture in a side of said pivot frame.

19. The method as recited in claim 15 further comprising:
removeably coupling an end frame to an outboard end of said first extender;
forming a slot in said outboard end; and
configuring a flop lock to align within said slot to enable said flop lock and a portion of said outboard end to pass through a third aperture in said end frame.

20. The method as recited in claim 19 further comprising rotatably coupling said flop lock to said outboard end, and configuring said flop lock to releaseably couple said end frame to said first extender.

21. The method as recited in claim 19 further comprising installing a pivot pin through said outboard end at said slot, said flop lock pivoting about said pivot pin.

22. The method as recited in claim 19 wherein said flop lock is unbalanced about said pivot pin.

23. The method as recited in claim 19 wherein said flop lock has a weighted end.

24. The method as recited in claim 19 further comprising installing an end stop proximate said outboard end, and said end frame is positionable on said first extender between said end stop and said flop lock.
